(19) United States
(12) Patent Application Publication
(10) Pub. No.: US 2026/0265998 A1
(43) Pub. Date: Sep. 10, 2026

(54) SHEET MANUFACTURING APPARATUS

(71) Applicant: SEIKO EPSON CORPORATION, Tokyo (JP)

(72) Inventors: Hiroyuki HIRAMATSU, Shiojiri (JP); Masaki OTA, Matsumoto (JP)

(21) Appl. No.: 19/560,464

(22) Filed: Mar. 9, 2026

(30) Foreign Application Priority Data
Mar. 10, 2025 (JP) 2025-037187

(51) Int. Cl. D21G 9/00

(52) U.S. Cl. CPC D21G 9/0027

(57) ABSTRACT

A sheet manufacturing apparatus for manufacturing a sheet from a material containing a fiber includes a web forming unit that forms a web by accumulating the material using airflow; a sheet forming unit that applies pressure to the web to form the sheet; a measuring unit that measures a thickness of the sheet and outputs a measurement result; and a control circuit that controls operation of the web forming unit. The web forming unit includes a web transport belt on which the material is accumulated and a drive unit that drives the web transport belt, and the control circuit controls an operation speed of the drive unit based on the measurement result.

The present application is based on, and claims priority from JP Application Serial Number 2025-037187, filed Mar. 10, 2025, the disclosure of which is hereby incorporated by reference herein in its entirety.

### BACKGROUND

### 1. Technical Field

The present disclosure relates to a sheet manufacturing apparatus.

### 2. Related Art

In the related art, as disclosed in JP-A-2021-30351, a slitter and a sheet manufacturing apparatus have been known that manufacture new paper by turning waste paper as a raw material into fibers using dry defibration and then performing pressing, heating, and cutting.

Waste paper as a raw material of a sheet generally includes multiple types of paper, and the amount of fibers that can be extracted from a certain amount of waste paper varies depending on the paper type. For this reason, depending on the type of paper included in the waste paper as a raw material, the thickness of the manufactured sheet may vary beyond an allowable limit.

### SUMMARY

According to an aspect of the present disclosure, a sheet manufacturing apparatus for manufacturing a sheet from a material containing a fiber includes a web forming unit that forms a web by accumulating the material using airflow; a sheet forming unit that applies pressure to the web to form the sheet; a measuring unit that measures a thickness of the sheet and outputs a measurement result; and a control circuit that controls operation of the web forming unit. The web forming unit includes a web transport belt on which the material is accumulated and a drive unit that drives the web transport belt, and the control circuit controls an operation speed of the drive unit based on the measurement result.

### BRIEF DESCRIPTION OF THE DRAWINGS

FIG. 1 is a schematic view illustrating a configuration of a sheet manufacturing apparatus according to an embodiment.

FIG. 2 is a perspective view illustrating a frame of the sheet manufacturing apparatus.

FIG. 3 is a side view illustrating a configuration of a measuring unit.

FIG. 4 is a perspective view illustrating the configuration of the measuring unit.

FIG. 5 is a side view illustrating the configuration of the measuring unit.

FIG. 6 is a block diagram of a control circuit.

### DESCRIPTION OF EMBODIMENTS

In the following embodiment, a sheet manufacturing apparatus 1 that recycles pieces of waste paper or the like in a dry process will be exemplified and described with reference to the accompanying drawings. The process performed by the sheet manufacturing apparatus of the present disclosure is not limited to a dry process and may be a wet process. In the present specification, the dry process refers to a process performed in air, such as the atmosphere, rather than in a liquid.

In each of the following drawings, XYZ axes are given as coordinate axes orthogonal to each other, a direction pointed by each arrow is defined as a positive direction, and a direction opposite to the positive direction is defined as a negative direction. The Z axis is a virtual axis extending in a vertical direction, a +Z direction is an upward direction, and a −Z direction is a downward direction. The −Z direction is a direction in which gravity acts. In addition, in the sheet manufacturing apparatus 1, a leading side in a transport direction of a raw material, a web, a sheet, and the like may be referred to as downstream, and a trailing side in the transport direction thereof may be referred to as upstream. For convenience of illustration, the size of each member is different from the actual size.

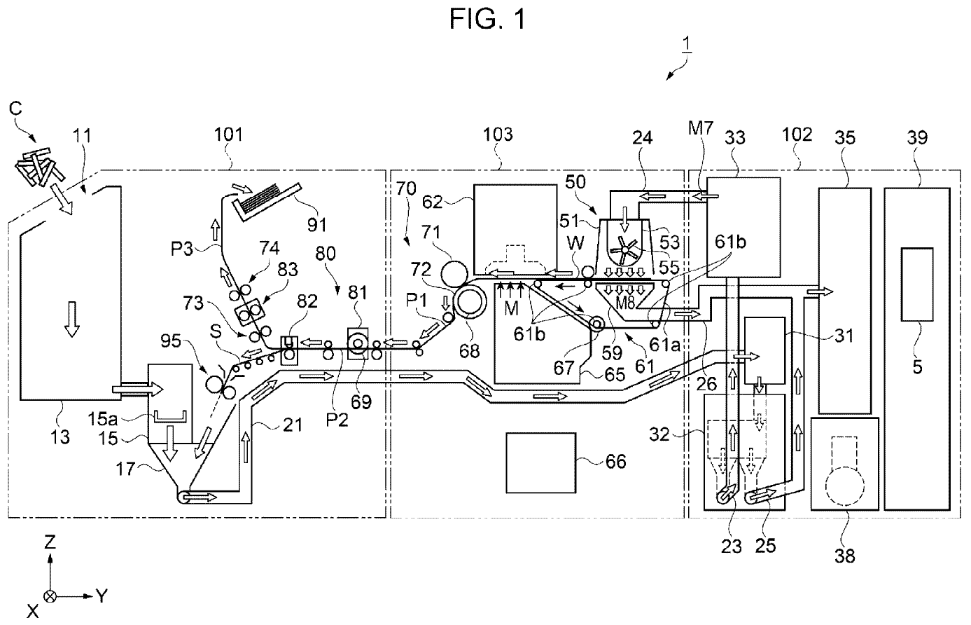

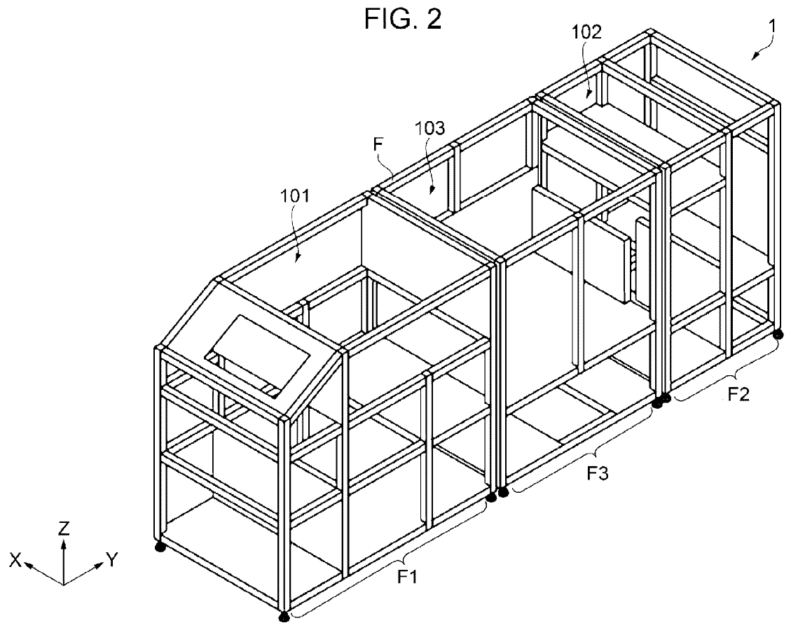

As illustrated in FIGS. 1 and 2, the sheet manufacturing apparatus 1 according to the embodiment includes a first unit group 101, a second unit group 102, and a third unit group 103. The sheet manufacturing apparatus 1 includes a first frame F1, a second frame F2, and a third frame F3. The first frame F1, the second frame F2, and the third frame F3 constitute a main body frame F. Although not illustrated, the sheet manufacturing apparatus 1 is provided with a housing that covers the first frame F1, the second frame F2, and the third frame F3.

In FIG. 1, directions in which a raw material C, a sheet P3, slit pieces S, scraps, and the like move are indicated by white arrows.

The sheet manufacturing apparatus 1 manufactures the sheet P3 from the raw material C. In the sheet manufacturing apparatus 1, the first unit group 101, the third unit group 103, and the second unit group 102 are arranged from the-Y direction side toward the +Y direction side.

The raw material C is transported from the first unit group 101 to the second unit group 102 through a pipe 21 extending across the third unit group 103. Then, the raw material C is subjected to defibration or the like in the second unit group 102 and is then transported to the third unit group 103 through a pipe 24. The raw material C is formed into a web W in the third unit group 103 and then formed into a continuous sheet P1. The continuous sheet P1 is cut into sheets P3 in the first unit group 101.

The first unit group 101 includes, as processing units, a buffer tank 13, a fixed-quantity feeding unit 15, a merging unit 17, a cutting unit 80, a measuring unit 83, a tray 91, and a shredding unit 95. The first unit group 101 is mounted on the first frame F1.

The raw material C is charged into the buffer tank 13 through a raw material inlet 11. The raw material C is a material containing a fiber such as cellulose and includes, for example, shredded pieces of waste paper. Humidified air is fed into the buffer tank 13 from the second humidifier 66 of the third unit group 103.

After the raw material C is temporarily stored in the buffer tank 13, the raw material C is transported to the fixed-quantity feeding unit 15 according to the operation of the sheet manufacturing apparatus 1. The sheet manufacturing apparatus 1 may include a shredder that shreds the waste paper or the like upstream of the buffer tank 13.

The fixed-quantity feeding unit 15 includes a measuring device 15a and a feeding mechanism (not illustrated). The measuring device 15a measures the mass of the raw material C. The feeding mechanism feeds the raw material C measured by the measuring device 15a to the downstream merging unit 17. That is, the fixed-quantity feeding unit 15 measures the raw material C with the measuring device 15a for each predetermined mass and feeds the raw material C to the downstream merging unit 17 by using the feeding mechanism.

In the present embodiment, a load cell is used as the measuring device 15a. The predetermined mass of the raw material C measured by the measuring device 15a is, for example, approximately several grams to several tens of grams.

A known technique such as a vibrating feeder is applicable to the feeding mechanism. The feeding mechanism may be included in the measuring device 15a.

The measurement and feeding of the raw material C at the fixed-quantity feeding unit 15 is batch processing. In other words, the raw material C is intermittently fed from the fixed-quantity feeding unit 15 to the merging unit 17. The fixed-quantity feeding unit 15 may include multiple measuring devices 15a, and the multiple measuring devices 15a may be operated at different times to improve the measurement efficiency.

In the merging unit 17, shredded pieces of slit pieces S fed from the shredding unit 95 are merged and mixed with the raw material C fed from the fixed-quantity feeding unit 15. The slit pieces S and the shredding unit 95 will be described later. The raw material C mixed with the shredded pieces flows from the merging unit 17 into the pipe 21.

The pipe 21 transports the raw material C from the first unit group 101 to the second unit group 102 using airflow generated by a blower (not illustrated).

The second unit group 102 includes, as processing units, a defibrating unit 31, a separating unit 32, a pipe 23, and a mixing unit 33. The second unit group 102 is mounted on the second frame F2. In the second unit group 102, these components are arranged in the above order from upstream to downstream. The second unit group 102 further includes a pipe 25 connected to the separating unit 32, a collection unit 35, a compressor 38, and a power supply unit 39.

The raw material C transported through the pipe 21 flows into the defibrating unit 31. The defibrating unit 31 defibrates the raw material C fed from the fixed-quantity feeding unit 15 into fibers in a dry process. A known defibrating mechanism is applicable to the defibrating unit 31.

The defibrating unit 31 has, for example, the following configuration. The defibrating unit 31 includes a stator and a rotor. The stator has a substantially cylindrical inner surface. The rotor is installed inside the stator and rotates along the inner surface of the stator. The small pieces of the raw material C are held between the inner surface of the stator and the rotor and are defibrated by a shearing force generated between them. Thus, the entangled fibers included in the paper pieces are unraveled, and the raw material C becomes a fibrous raw material C. The fibrous raw material C is transported to the separating unit 32.

The separating unit 32 removes substances unnecessary for manufacturing the sheet P3 from the fibrous raw material C. Specifically, the separating unit 32 separates fibers into relatively long fibers and relatively short fibers. The relatively short fibers are separated by the separating unit 32 because the relatively short fibers may cause a decrease in strength of the sheet P3. In addition, the separating unit 32 also separates and removes other materials, such as coloring materials and additives contained in the waste paper C. A known technique such as a disc mesh technique is applicable to the separating unit 32.

The air humidified by the second humidifier 66 of the third unit group 103 is fed into the separating unit 32.

The raw material C is transported to the mixing unit 33 through the pipe 23. The unnecessary substances such as relatively short fibers and coloring materials are discharged to the collection unit 35 through the pipe 25.

The mixing unit 33 mixes the raw material C with a binder or the like in the air to form a mixture M7. Although not illustrated, the mixing unit 33 includes a flow path through which the raw material C is transported, a fan, a storage tank, a feeding pipe, and a valve.

The storage tank is in communication with the flow path for the raw material C via the feeding pipe. The valve is provided in the feeding pipe between the storage tank and the flow path. The storage tank feeds a binder such as starch into the flow path. The valve adjusts the mass of the binder to be fed from the storage tank to the flow path. Thus, the mixing ratio of the raw material C and the binder is adjusted.

In addition to the above-described components for feeding the binder, the mixing unit 33 may include a similar component that feeds a coloring material, an additive, or the like.

The fan of the mixing unit 33 generates airflow that forms the mixture M7 by mixing a binder and the like with the raw material C in air while transporting the raw material C downstream. The mixture M7 flows from the mixing unit 33 into the pipe 24.

The collection unit 35 includes a suction pump (not illustrated). The collection unit 35 sucks the relatively short fibers separated in the separating unit 32 through the pipe 25. In addition, the collection unit 35 sucks paper dust M8 (described later) fed from the third unit group 103.

The collection unit 35 includes a filter (not illustrated). The filter filters out the unnecessary substances of the raw material C fed from the separating unit 32 and the paper dust M8 fed from the third unit group 103.

The compressor 38 generates compressed air. The above-described filter may be clogged with fine particles and the like of the unnecessary substances. The filter can be cleaned by blowing the compressed air generated by the compressor 38 onto the filter to blow off adhering particles.

The power supply unit 39 includes a power supply device that supplies power to the sheet manufacturing apparatus 1 in addition to a control unit 5. The power supply unit 39 distributes the power supplied from outside the apparatus 1 to the components of the sheet manufacturing apparatus 1. The control unit 5 is an example of a control circuit that controls the operation of the components of the sheet manufacturing apparatus 1.

The third unit group 103 includes, as processing units, an accumulation unit 50, a suction unit 59, a first transport unit 61, a second transport unit 62, a first humidifier 65, a second humidifier 66, and a heating roller unit 70. The third unit group 103 is mounted on the third frame F3. In the third unit group 103, the accumulation unit 50, the first transport unit 61, the second transport unit 62, the first humidifier 65, and the heating roller unit 70 are arranged in this order from upstream to downstream.

The accumulation unit 50 is a fiber accumulation unit that generates the web W by accumulating the mixture M7 using airflow. The accumulation unit 50 includes a drum member 53, a blade member 55 disposed in the drum member 53, a housing 51 that accommodates the drum member 53, and a suction unit 59. The mixture M7 is taken into the drum member 53 through the pipe 24.

The first transport unit 61 is located below the drum member 53. The first transport unit 61 includes a web transport belt 61a, five drive rollers 61a around which the web transport belt 61b is stretched, and a drive unit 67 that drives the web transport belt 61a. The suction unit 59 faces the drum member 53 with the web transport belt 61a interposed therebetween in the direction along the Z axis. That is, the drum member 53 is located above the web transport belt 61a.

The blade member 55 is located inside the drum member 53 and is rotationally driven by a motor (not illustrated). The drum member 53 is a half-cylindrical sieve. The drum member 53 has a mesh having a sieve function on a surface facing downward. The drum member 53 allows particles such as fibers and binders smaller than the mesh openings of the sieve to pass from the inside to the outside.

The mixture M7 is discharged to the outside of the drum member 53 while being stirred by the rotating blade member 55 in the drum member 53. The air humidified by the second humidifier 66 is fed into the drum member 53.

The mixture M7 is dispersed in the air in the housing 51 and is discharged through the opening in the bottom surface of the housing 51 by using airflow generated by gravity and suction of the suction unit 59, and thus the mixture M7 is accumulated on an upper surface of the web transport belt 61a to form the web W. The mixture M7 that did not form the web W, that is, the mixture M7 that passed through the web transport belt 61a is sucked by the suction unit 59 as the paper dust M8.

The suction unit 59 is disposed below the drum member 53 and the web transport belt 61a and is a suction mechanism that sucks air from below the web transport belt 61a. The suction unit 59 generates airflow, sucks the paper dust M8 together with air, and feeds the paper dust M8 to the collection unit 35 through a discharge pipe 26.

The web transport belt 61a is an endless belt and is stretched by five drive rollers 61b. The web transport belt 61a is rotated counterclockwise in FIG. 1 by the rotation of the drive rollers 61b. Thus, the mixture M7 is continuously accumulated on the web transport belt 61a to form the web W. The web W contains a relatively large amount of air and is soft and swollen. The first transport unit 61 transports the formed web W downstream by the rotation of the web transport belt 61a.

The drive unit 67 is a drive motor that rotationally drives the drive rollers constituting the drive rollers 61b. That is, the drive unit 67 drives the web transport belt 61a. In the present embodiment, the accumulation unit 50, the first transport unit 61, and the suction unit 59 constitute a web forming unit.

The second transport unit 62 is located downstream of the first transport unit 61 and is a transport unit that transports the web W in place of the first transport unit 61. The second transport unit 62 peels off the web W from the upper surface of the web transport belt 61a and transports the web W toward the heating roller unit 70. The second transport unit 62 is located above the transport path of the web W. An upstream portion of the second transport unit 62 overlaps the web transport belt 61a in the vertical direction.

The second transport unit 62 includes a transport belt, multiple rollers, and a suction mechanism (not illustrated). The transport belt has multiple holes through which the air passes. The transport belt is stretched around the rollers and is rotated by rotation of the rollers.

The second transport unit 62 attracts an upper surface of the web W to a lower surface of the transport belt by using a negative pressure generated by the suction mechanism. When the transport belt rotationally moves in this state, the web W is transported downstream while being attracted to the transport belt.

The first humidifier 65 is an ultrasonic humidifier and feeds mist M from below to humidify the web W transported by the second transport unit 62. The first humidifier 65 is disposed below the second transport unit 62 and faces the web W transported by the second transport unit 62 in the direction along the Z axis.

Moistening the web W with the mist M improves the function of starch as the binder and improves the strength of the sheet P3. Furthermore, since the web W is humidified from below, droplets derived from the mist M do not fall onto the web W. In addition, since the web W is moistened from the side opposite to the contact surface between the transport belt and the web W, the web W is less likely to stick to the transport belt. The second transport unit 62 transports the web W to the heating roller unit 70.

The heating roller unit 70 is a heating roller unit that heats and applies pressure to compress the web W, which is formed of accumulated fibers, to form a continuous sheet P1. The heating roller unit 70 includes a pair of heating rollers 71 and 72. The heating rollers 71 and 72 each have a built-in electric heater and can heat the roller surface. The heating roller unit 70 is an example of a sheet forming unit that forms the web W into the continuous sheet P1.

The web W is continuously passed between the two heating rollers 71 and 72 and is subjected to press-working while being heated. Thus, the air contained in the soft web W, which contains a relatively large amount of air, is reduced, and the fibers of the web W are bonded to each other by the binder, forming the continuous sheet P1. The continuous sheet P1 is transported to the first unit group 101 by the transport roller.

The second humidifier 66 is located below the first humidifier 65. The second humidifier 66 is an evaporative humidifier. The second humidifier 66 feeds the humidified air into the buffer tank 13, the separating unit 32, and the drum member 53 through multiple pipes (not illustrated). In each of the above components, the humidified air reduces charging of the fibers and particles of the raw material C and reduces adhesion of the components caused by static electricity.

The continuous sheet P1 transported to the first unit group 101 reaches the cutting unit 80. The cutting unit 80 is located downstream of the heating roller unit 70 in the transport direction of the sheet P1 and cuts the sheet P1 into a predetermined length. The cutting unit 80 includes a first cutting unit 81 located upstream and a second cutting unit 82 located downstream. The first cutting unit 81 is a rotary cutter that cuts the continuous sheet P1 in a direction intersecting the transport direction, for example, in a direction along the X axis. The first cutting unit 81 is driven by a drive unit 69 including a motor. The continuous sheet P1 is cut into cut sheets P2 in the first cutting unit 81. The cut sheets P2 are transported from the first cutting unit 81 to the second cutting unit 82.

The second cutting unit 82 cuts the cut sheet P2 in the transport direction, for example, in the direction along the Y axis. Specifically, the second cutting unit 82 cuts the vicinity of opposite side edges of the cut sheet P2 in the direction along the X axis. Thus, the cut sheet P2 becomes a sheet P3 having a predetermined shape, such as an A4 size or an A3 size.

When each cut sheet P2 is cut into the sheet P3 in the second cutting unit 82, the slit pieces S as trimmings are generated. The slit pieces S are transported substantially in the-Y direction to the shredding unit 95, which is a shredder. The shredding unit 95 shreds the slit pieces S into shredded pieces, and the shredded pieces are fed to the merging unit 17. A mechanism that measures the shredded pieces of the slit pieces S and feeds them to the merging unit 17 may be disposed between the shredding unit 95 and the merging unit 17.

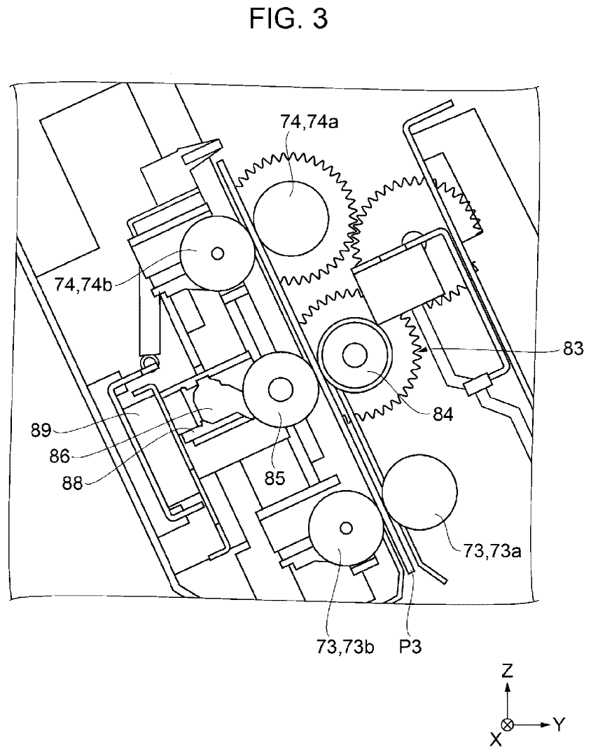

As illustrated in FIGS. 1 and 3, the sheet P3 cut in the second cutting unit 82 is transported toward a pre-measurement transport roller pair 73. The pre-measurement transport roller pair 73 includes an upper roller 73a and a lower roller 73b. One of the upper roller 73a and the lower roller 73b of the pre-measurement transport roller pair 73 is a drive roller and is rotationally driven by a drive motor (not illustrated). The other roller is a driven roller.

The thickness of the sheet P3 that has passed through the pre-measurement transport roller pair 73 is measured by the measuring unit 83. The sheet P3 whose thickness has been measured by the measuring unit 83 is transported toward a post-measurement transport roller pair 74. Details of the measuring unit 83 will be described later.

The post-measurement transport roller pair 74 includes an upper roller 74a and a lower roller 74b. One of the upper roller 74a and the lower roller 74b of the post-measurement transport roller pair 74 is a drive roller and is rotationally driven by a drive motor (not illustrated). The other roller is a driven roller.

The sheet P3 transported from the post-measurement transport roller pair 74 is transported obliquely upward and stacked on the tray 91. The sheet P3 is applicable as an alternative to, for example, copy paper.

The measuring unit 83 is located downstream of the cutting unit 80, that is, located downstream of the second cutting unit 82. The measuring unit 83 measures the thickness of the sheet P3 cut by the second cutting unit 82 and outputs the measurement result to the control unit 5. With this configuration, the sheet manufacturing apparatus 1 can measure the thicknesses of the sheet P3 after the sheet P3 is formed, and thus the obtained thickness of the sheet P3 is more accurate. The measuring unit 83 includes a measurement drive roller 84, a measurement transport roller 85, a displacement sensor 86, a suspension 88, and a measurement bracket 89.

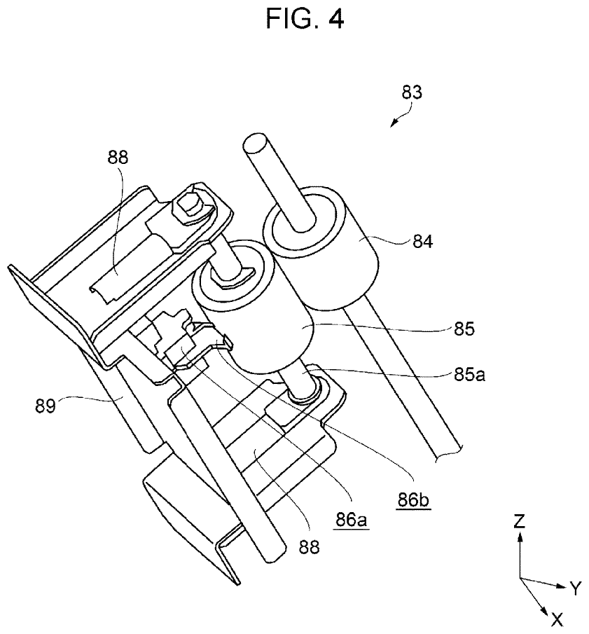

As illustrated in FIGS. 3 and 4, the measurement drive roller 84 is a drive roller that faces the measurement transport roller 85 and nips and transports the sheet P3. The measurement drive roller 84 is rotationally driven by a drive motor (not illustrated). The measurement drive roller 84 is a rubber roller. Thus, when the measurement drive roller 84 nips and transports the sheet P3, the sheet P3 is unlikely to slip. The measurement drive roller 84 is rotatably held by the first frame F1.

The measurement transport roller 85 is a transport roller that faces the measurement drive roller 84 and nips and transports the sheet P3 together with the measurement drive roller 84. The measurement transport roller 85 is a driven roller driven by the measurement drive roller 84. The measurement transport roller 85 is rotatably held by the suspension 88 via a driven shaft 85a serving as a rotation shaft.

The suspension 88 is a rod member that can be expanded and contracted by a spring. One end of the suspension 88 is fixed to the measurement bracket 89 and the other end holds the driven shaft 85a. In this embodiment, two suspensions 88 rotatably hold the two ends of the driven shaft 85a. The suspension 88 functions as a suspension mechanism capable of changing the position of the measurement transport roller 85 with respect to the measurement drive roller 84.

The displacement sensor 86 is a contact lever sensor that comes into contact with the transport surface of the measurement transport roller 85 and measures the displacement of the measurement transport roller 85. The displacement sensor 86 includes a main body 86a and a lever 86b. The lever 86b is a measuring element of the displacement sensor 86. The lever 86b is swingably attached to the main body 86a so as to follow a change in the position of the measurement transport roller 85. The lever 86b swings in a state in which the lever 86b is urged against the measurement transport roller 85 by an urging member (not illustrated), such as a spring, so that the lever 86b is always in contact with the measurement transport roller 85.

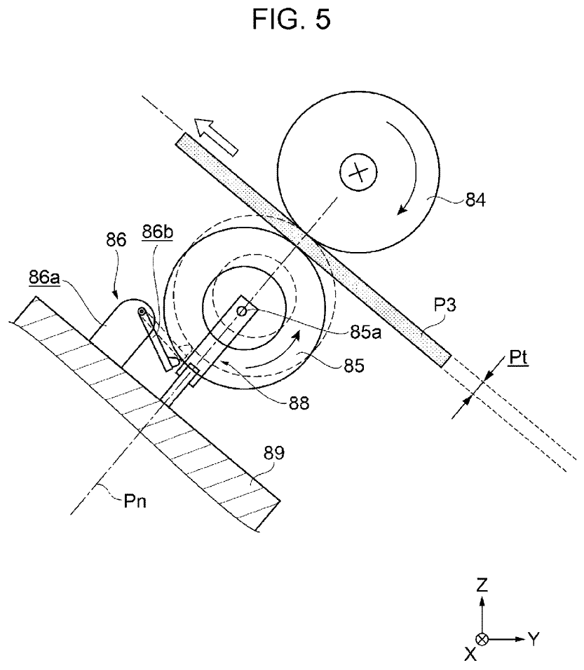

FIG. 5 is a view illustrating a state in which the measuring unit 83 is not measuring the sheet P3 and a state in which the measuring unit 83 is measuring the sheet P3. As illustrated in FIG. 5, the measurement transport roller 85 and the lever 86b in a state in which the measuring unit 83 is not measuring the sheet P3 are indicated by broken lines. When the measuring unit 83 is not measuring the sheet P3, the suspension 88 biases the measurement transport roller 85 toward the measurement drive roller 84 to bring the measurement transport roller 85 into contact with the measurement drive roller 84.

When the measuring unit 83 is measuring the sheet P3, the suspension 88 biases the measurement transport roller 85 toward the measurement drive roller 84. Thus, the sheet P3 is nipped between the measurement transport roller 85 and the measurement drive roller 84. The measurement transport roller 85 and the lever 86b in this state are indicated by solid lines in FIG. 5. However, compared to when the measuring unit 83 is measuring the sheet P3, the measurement transport roller 85 is displaced away from the sheet P3 in the direction along the normal line Pn by the thickness Pt of the sheet P3. When the measurement transport roller 85 is displaced, the lever 86b also swings in response to the displacement of the measurement transport roller 85. The main body 86a measures the thicknesses Pt of the sheet P3 based on the posture of the lever 86b that swung in response to the displacement of the measurement transport roller 85. Specifically, the main body 86a includes an encoder (not illustrated) capable of detecting the posture of the lever 86b and outputs a detection value of the encoder to the control unit 5 as information indicating the thickness Pt of the sheet P3. With this configuration, since the measuring unit 83 detects the thickness of the sheet P3 based on the displacement of the measurement transport roller 85, the thickness of the sheet P3 can be detected with a simple configuration.

The position at which the lever 86b comes into contact with the measurement transport roller 85 is preferably close to the normal line Pn of the sheet P3 that passes through the center of the driven shaft 85a of the measurement transport roller 85, and is more preferably on the normal line Pn. The displacement sensor 86 is not limited to the contact lever sensor and may be a position measurement sensor such as an optical sensor or an infrared sensor.

The measurement bracket 89 is a bracket member formed of sheet metal. The measurement bracket 89 holds the measurement transport roller 85, the suspensions 88, and the displacement sensor 86. The measurement bracket 89 is mounted on the first frame F1 in a state in which the measurement transport roller 85 and the measurement drive roller 84 face each other in a nip-capable condition.

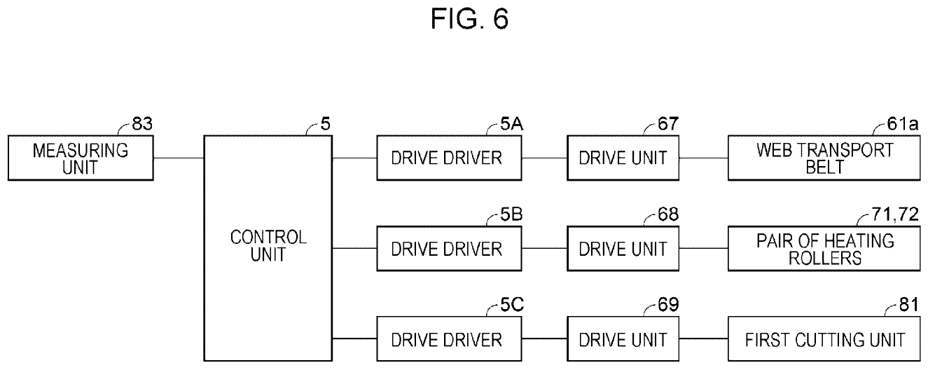

As illustrated in FIG. 6, the sheet manufacturing apparatus 1 includes a drive driver 5A for operating the drive unit 67 of the first transport unit 61, a drive driver 5B for operating the drive unit 68 of the heating roller unit 70, and a drive driver 5C for operating the drive unit 69 of the cutting unit 80. The drive drivers 5A, 5B, and 5C operate based on the control of the control unit 5.

The control unit 5 controls the drive drivers 5A, 5B, and 5C based on the measurement result obtained by the measuring unit 83. Specifically, the control unit 5 adjusts the operation speed of the drive unit 67, that is, the movement speed of the web transport belt 61a by controlling the drive driver 5A based on the measurement result obtained by the measuring unit 83. The movement speed of the web transport belt 61a is equal to the transport speed of the web W. In addition, the control unit 5 controls the drive drivers 5B and 5C to adjust the rotation speed of the heating roller 71 and the cut speed of the first cutting unit 81 to speeds corresponding to the adjusted transport speed of the web W.

The transport speed of the web W is calculated using, for example, Formula (1) below. In Formula (1), Pt1 is a thickness of the sheet P3 measured by the measuring unit 83, and Pt2 is a target thickness of the sheet P3. In addition, V1 is a transport speed at the time when the thicknesses of the sheet P3 is measured by the measuring unit 83, that is, the transport speed before the adjustment, and V2 is the transport speed after the adjustment.

$$V 2 = Pt 1 / Pt 2 \times V 1 \qquad ( 1 )$$

When the thickness of the sheet P3 measured by the measuring unit 83 is less than the target value, the control unit 5 controls the drive driver 5A, 5B, and 5C to decrease the operation speeds of the drive unit 67, the drive unit 68, and the drive unit 69. When the control unit 5 decreases the operation speed of the drive unit 67, the transport speed of the web W decreases. When the transport speed of the web W decreases, the amount of the mixture M7 accumulated on the web transport belt 61a increases, and the sheet P3 becomes thicker. With this configuration, when the measurement result is thinner than the lower target value, the control unit 5 decreases the operation speed of the drive unit 67, preventing the sheet P3 from becoming too thin.

When the thickness of the sheet P3 measured by the measuring unit 83 is greater than the target value, the control unit 5 controls the drive driver 5A, 5B, and 5C to increase the operation speeds of the drive unit 67, the drive unit 68, and the drive unit 69. When the control unit 5 increases the operation speed of the drive unit 67, the transport speed of the web W increases. When the transport speed of the web W increases, the amount of the mixture M7 accumulated on the web transport belt 61a decreases, and the sheet P3 becomes thinner. With this configuration, when the measurement result is thicker than the upper target value, the control unit 5 increases the operation speed of the drive unit 67, preventing the sheet P3 from becoming too thick.

What is claimed is:

1. A sheet manufacturing apparatus for manufacturing a sheet from a material containing a fiber, the sheet manufacturing apparatus comprising:
a web forming unit that forms a web by accumulating the material using airflow;
a sheet forming unit that applies pressure to the web to form the sheet;
a measuring unit that measures a thickness of the sheet and outputs a measurement result; and
a control circuit that controls operation of the web forming unit, wherein
the web forming unit includes a web transport belt on which the material is accumulated and a drive unit that drives the web transport belt, and
the control circuit controls an operation speed of the drive unit based on the measurement result.

2. The sheet manufacturing apparatus according to claim 1, wherein
the control circuit increases the operation speed of the drive unit when the measurement result is thicker than an upper target value.

3. The sheet manufacturing apparatus according to claim 1, wherein
the control circuit decreases the operation speed of the drive unit when the measurement result is thinner than a lower target value.

4. The sheet manufacturing apparatus according to claim 1, wherein
the drive unit includes a drive roller and a drive motor that rotates the drive roller.

5. The sheet manufacturing apparatus according to claim 1, wherein
the measuring unit includes a transport roller that transports the sheet and a displacement sensor that measures displacement of the transport roller.

6. The sheet manufacturing apparatus according to claim 1, further comprising
a cutting unit that is located downstream of the sheet forming unit in a transport direction of the sheet and cuts the sheet at a predetermined length.

7. The sheet manufacturing apparatus according to claim 6, wherein
the measuring unit is located downstream of the cutting unit in the transport direction of the sheet.
